(19) United States
(12) Patent Application Publication
(10) Pub. No.: US 2026/0212517 A1
(43) Pub. Date: Jul. 23, 2026

(54) MODEL TRAINING METHOD, DEPTH PREDICTION METHOD, AND DEVICE

(71) Applicant: Beijing Zitiao Network Technology Co., Ltd., Beijing (CN)

(72) Inventors: Sili CHEN, Beijing (CN); Shengnan ZHU, Beijing (CN); Feihu ZHANG, Beijing (CN); Hengkai GUO, Beijing (CN)

(21) Appl. No.: 19/455,707

(22) Filed: Jan. 21, 2026

(30) Foreign Application Priority Data
Jan. 21, 2025 (CN) 202510097518.X

(51) Int. Cl. G06T 7/50

(52) U.S. Cl. CPC G06T 7/50; G06T 2207/20081

(57) ABSTRACT

A method includes: obtaining a training dataset; determining, with a depth estimation model to be trained, a sequence of prediction depth maps corresponding to the sequence of sample video frames, the sequence of prediction depth maps including a plurality of first prediction depth maps; and updating, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

### CROSS-REFERENCE

This application claims the priority of Chinese Patent Application No. 202510097518.X, filed on Jan. 21, 2025, entitled “MODEL TRAINING METHOD, DEPTH PREDICTION METHOD, APPARATUS, DEVICE AND STORAGE MEDIUM”, the entire content of which is incorporated herein by reference.

### FIELD

Example embodiments of the present disclosure generally relate to the field of computers, and in particular, to a model training method, a depth prediction method, and a device.

### BACKGROUND

The depth estimation aims to estimate depth information (also referred to as distance information) from each point in a two-dimensional image to a camera. A map formed of such depth information may be referred to as a depth map. The depth estimation plays an important role in many application scenarios, such as three-dimensional reconstruction, augmented reality, autonomous driving, and the like. The performance of traditional video depth estimation technologies in terms of temporal consistency still needs to be improved.

### SUMMARY

In a first aspect of the present disclosure, a model training method is provided. The method includes: obtaining a training dataset including at least a sequence of sample video frames and a sequence of ground truth depth maps corresponding to the sequence of sample video frames, the sequence of ground truth depth maps including a plurality of first ground truth depth maps; determining, with a depth estimation model to be trained, a sequence of prediction depth maps corresponding to the sequence of sample video frames, the sequence of prediction depth maps including a plurality of first prediction depth maps; and updating, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

In a second aspect of the present disclosure, a depth prediction method is provided. The method includes: determining, from a video, a set of video frames for a current inference cycle, the set of video frames including a plurality of target video frames to be inferred and at least one overlap frame that has been inferred in a previous inference cycle and at least one reference frame, the at least one overlap frame being adjacent to the plurality of target video frames, and the at least one reference frame being located at a predetermined position of at least one set of video frames corresponding to at least one previous inference cycle, respectively; determining a sequence of input feature representations corresponding to the set of video frames; determining, with a trained depth estimation model and based on the sequence of input feature representations, a sequence of output feature representations indicating depth information; and determine, based on the sequence of output feature representations, a plurality of target depth maps corresponding to the plurality of target video frames, each of the target depth maps including depth information corresponding to the respective target video frame.

In a third aspect of the present disclosure, an apparatus for model training is provided. The apparatus includes: a dataset obtaining module configured to obtain a training dataset including at least a sequence of sample video frames and a sequence of ground truth depth maps corresponding to the sequence of sample video frames, the sequence of ground truth depth maps including a plurality of first ground truth depth maps; a prediction depth determining module configured to determine, with a depth estimation model to be trained, a sequence of prediction depth maps corresponding to the sequence of sample video frames, the sequence of prediction depth maps including a plurality of first prediction depth maps; and a model parameter updating module configured to update, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

In a fourth aspect of the present disclosure, an apparatus for depth prediction is provided. The apparatus includes: a video frame determining module configured to determine, from a video, a set of video frames for a current inference cycle, the set of video frames including a plurality of target video frames to be inferred and at least one overlap frame that has been inferred in a previous inference cycle and at least one reference frame, the at least one overlap frame being adjacent to the plurality of target video frames, and the at least one reference frame being located at a predetermined position of at least one set of video frames corresponding to at least one previous inference cycle, respectively; an input feature determining module configured to determine a sequence of input feature representations corresponding to the set of video frames; an output feature determining module configured to determining, with a trained depth estimation model and based on the sequence of input feature representations, a sequence of output feature representations indicating depth information; and a depth map determining module configured to determine, based on the sequence of output feature representations, a plurality of target depth maps corresponding to the plurality of target video frames, each of the target depth maps including depth information corresponding to the respective target video frame.

In a fifth aspect of the present disclosure, an electronic device is provided. The device includes at least one processor; and at least one memory coupled to the at least one processor and storing instructions for execution by the at least one processor. The instructions, when executed by the at least one processor, cause the device to perform the method of the first aspect or the second aspect.

In a sixth aspect of the present disclosure, a computer-readable storage medium is provided. The computer readable storage medium has computer-executable instructions stored thereon. The computer-executable instructions are executable by a processor to implement the method of the first aspect or the second aspect.

In a seventh aspect of the present disclosure, a computer executable instruction product is provided. The computer executable instruction product includes computer executable instructions, where the computer executable instructions, when executed by a processor, implement the method of the first aspect or the second aspect of the present disclosure.

It should be understood that the content described in this Summary section is not intended to limit the key features or critical features of the embodiments of the present disclosure, nor is it intended to limit the scope of the present disclosure. Other features of the present disclosure will be readily understood from the following description.

### BRIEF DESCRIPTION OF DRAWINGS

The above and other features, advantages, and aspects of various embodiments of the present disclosure will become more apparent from the following detailed description taken in connection with the accompanying drawings. In the drawings, the same or similar reference signs refer to the same or similar elements, where:

FIG. 1 illustrates a schematic diagram of an example environment in which embodiments according to the present disclosure may be implemented;

FIG. 2 illustrates a flowchart of a model training process according to some embodiments of the present disclosure;

FIG. 3 illustrates a schematic diagram of an example architecture of model training according to some embodiments of the present disclosure;

FIG. 4A and FIG. 4B respectively illustrate schematic diagrams of example scenarios of model training according to some embodiments of the present disclosure;

FIG. 5 illustrates a schematic diagram of an example architecture of a depth estimation model according to some embodiments of the present disclosure;

FIG. 6 illustrates a flowchart of a process of depth prediction according to some embodiments of the present disclosure;

FIG. 7 illustrates a schematic diagram of an example architecture of depth prediction according to some embodiments of the present disclosure;

FIG. 8 illustrates a schematic structural block diagram of an example apparatus for model training according to some embodiments of the present disclosure;

FIG. 9 illustrates a schematic structural block diagram of an example apparatus for depth prediction according to some embodiments of the present disclosure; and

FIG. 10 illustrates a block diagram of an electronic device capable of implementing various embodiments of the present disclosure.

### DETAILED DESCRIPTION

Embodiments of the present disclosure will be described in more detail below with reference to the accompanying drawings. While certain embodiments of the present disclosure are shown in the accompanying drawings, it should be understood that the present disclosure may be implemented in various forms and should not be construed as limited to the embodiments set forth herein, but rather, these embodiments are provided for a more thorough and complete understanding of the present disclosure. It should be understood that the drawings and embodiments of the present disclosure are for illustrative purposes only and are not intended to limit the scope of the present disclosure.

In the description of the embodiments of the present disclosure, the terms “comprising/including” and its equivalents should be construed as being open-ended inclusive, i.e., “including, but not limited to”. The term “based on” should be construed as “based at least in part on”. The terms “one embodiment” or “the embodiment” should be construed as “at least one embodiment”. The term “some embodiments” should be understood as “at least some embodiments”. Other definitions, either explicit or implicit, may also be included below.

Herein, unless explicitly stated, performing one step “in responding to A” does not imply that this step is performed immediately after “A”, but one or more intermediate steps may be included.

It should be understood that the data involved in the technical solution (including but not limited to the data itself, the acquisition or use of the data) should comply with the requirements of the corresponding laws and regulations and related provisions.

It should be understood that before using the technical solutions disclosed in the implementations of the present disclosure, the user should be informed of the types, use ranges, use scenarios, and the like of the personal information related to the present disclosure in an appropriate manner according to relevant laws and regulations and acquire the user's authorization.

For example, in response to receiving an active request from a user, prompt information is sent to the user to explicitly prompt the user that the requested operations to be performed would require acquisition and use of personal information of the user. Thus, the user can autonomously select whether to provide personal information to software or hardware such as an electronic device, an application, a server, or a storage medium that performs the operations of the technical solution of the present disclosure, according to the prompt information.

As an optional but non-limiting implementation, in response to receiving an active request from a user, the prompt information may be sent to the user, for example, in the form of a pop-up window in which the prompt information is presented in the form of text. In addition, the pop-up window may further carry a selection control for the user to select “agree” or “disagree” to provide personal information to the electronic device.

It should be understood that the above process for notifying and acquiring user authorization is merely illustrative, and does not limit the implementations of the present disclosure, and other manners that satisfy related laws and regulations may also be applied to the implementations of the present disclosure.

As used herein, the term “model” may learn an association relationship between respective inputs and respective outputs from training data. Therefore, a corresponding output may be generated for a given input after training is complete. The generation of the model may be based on machine learning techniques. Deep Learning is a machine learning algorithm that processes inputs and provides corresponding outputs by using a multi-layer processing unit. The neural network model is one example of a deep learning-based model. As used herein, a “model” may also be referred to as a “machine learning model,” a “learning model,” a “machine learning network,” or a “learning network”. These terms can be used interchangeably herein.

A “neural network” is a deep learning-based machine learning network. The neural network is capable of processing inputs and providing corresponding outputs, which typically include an input layer and an output layer and one or more hidden layers between the input layer and the output layer. Neural networks used in deep learning applications typically include many hidden layers, increasing the depth of the network. Each layer of the neural network is connected in sequence such that the output of the previous layer is provided as an input to the next layer, where the input layer receives the input of the neural network and the output of the output layer serves as the final output of the neural network. Each layer of the neural network includes one or more nodes (also referred to as processing nodes or neurons), and each node processing input from the previous layer.

Generally, machine learning may generally include three stages, a training stage, a testing stage, and an application stage (also referred to as an inference stage). At the training stage, a given model may be trained using a large amount of training data, and constantly updating the parameter values, until the model is able to obtain consistent inferences that satisfy the expected objectives from the training data. Through training, the model may be considered to be able to learn an association between an input and an output (also referred to as a mapping from input to output) from the training data. The parameter values of the trained model are determined. In the testing stage, the test input is applied to the trained model to test whether the model can provide the correct output, thereby determining the performance of the model. In the application stage, the model may be used to process the actual input based on the parameter value obtained by training, to determine a corresponding output.

As mentioned above, the depth estimation aims to estimate depth information (also referred to as distance information) from each point in the two-dimensional image to the camera. A map formed of such information may be referred to as a depth map. The depth estimation plays an important role in many application scenarios, such as three-dimensional reconstruction, augmented reality, autonomous driving, and the like.

Early video depth estimation methods are generally based on traditional geometric principles. Depth of an object is calculated with disparity information and geometric constraints based on images captured from different perspectives. These methods have high computational amount and limited precision. After machine learning has emerged, some video depth estimation technologies based on machine learning models are constantly emerging. Some models warp features with optical flow, and some other models rely on relative poses between frames to construct a cost volume. However, the performance of such models may be affected by inaccurate optical flow or pose estimation errors. In the case of complex scenes or drastic motions, the effect of depth estimation may be greatly affected.

Recently, monocular depth estimation (MDE) has achieved remarkable progress, featuring strong generalization ability and relatively high computational efficiency. However, such models are mainly for static images, with poor temporal consistency, and flicker and motion blur easily occur when it comes to videos. The application of the model in the fields of robots, enhanced display, advanced video editing and the like with high requirements on temporal consistency is limited.

To constrain temporal consistency, some video depth estimation models propose an optical flow-based warping (OPW) loss under the assumption that depth information between corresponding locations of adjacent frames identified by optical flow is consistent, and to calculate a loss after obtaining corresponding points based on optical flow and warping. However, depth information between corresponding locations of adjacent frames remains consistent only when adjacent frames are stationary. In the case where the adjacent frame is in the non-stationary state, the depth information between the corresponding locations of the adjacent frames changes, causing the foregoing hypothesis to not be satisfied. This results in a limited effect of OPW loss on temporal consistency, causing the video depth estimation model trained with OPW loss having a poor performance of temporal consistency in complex scenarios or motion scenarios.

In view of this, embodiments of the present disclosure provide an improved solution for model training. In this solution, a training dataset is obtained, the training dataset includes at least a sequence of sample video frames and a sequence of ground truth depth maps corresponding to the sequence of sample video frames, and the sequence of ground truth depth maps includes a plurality of first ground truth depth maps. With a depth estimation model to be trained, a sequence of prediction depth maps corresponding to the sequence of sample video frames is determined, and the sequence of prediction depth maps includes a plurality of first prediction depth maps. Then, a model parameter in the depth estimation model is updated based on a first difference between the sequence of prediction depth maps and the sequence of ground truth depth maps to train the depth estimation model. The first difference herein indicates a difference between a first depth change amount and a second depth change amount. The first depth change amount indicates a depth information change amount between adjacent first ground truth depth maps in the sequence of ground truth depth maps. The second depth change amount indicates a depth information change amount between adjacent first prediction depth maps in the sequence of prediction depth maps.

In the embodiments of the present disclosure, it is considered that the depth information change amount between adjacent video frames determined with the depth estimation model should be consistent with the ground truth depth information change amount between the adjacent video frames. Based on this, embodiments of the present disclosure update the model parameter in the depth estimation model based on the first difference between the sequence of prediction depth maps and the sequence of ground truth depth maps to train the depth estimation model. Therefore, the temporal consistency of the depth estimation model can be effectively constrained, and the trained depth estimation model has a better performance in terms of temporal consistency.

Various example implementations of this solution are described in detail below in conjunction with the accompanying drawings.

### Example Environment

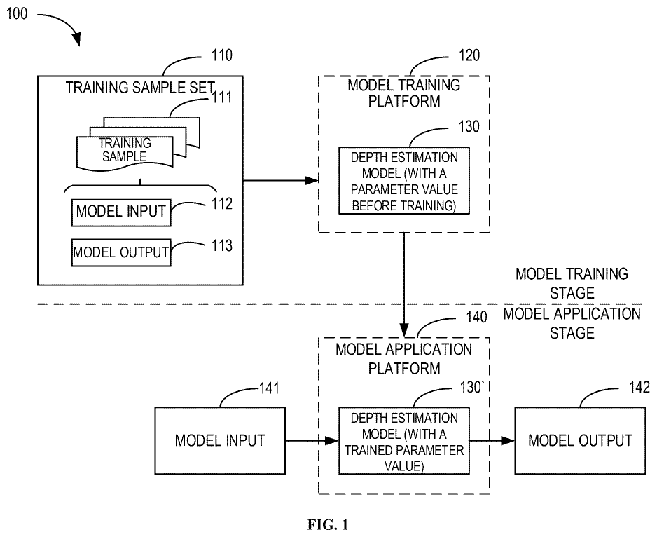

FIG. 1 illustrates a schematic diagram of an example environment 100 in which embodiments of the present disclosure can be implemented. In the environment 100 of FIG. 1, it is desirable to train and use such a depth estimation model 130 configured for estimating depth information of a video or image.

As shown in FIG. 1, the environment 100 includes a training sample set 110, a model training platform 120, and a model application platform 140. The upper part of FIG. 1 illustrates the process of the model training stage, and the lower part illustrates the process of the model application stage. Before training, the parameter value of the depth estimation model 130 may have an initial value, or may have a parameter value obtained through a pre-training process.

In the model training stage, the depth estimation model 130 may be trained based on a training sample set 110 including a plurality of training samples 111 by using the model training platform 120. Here, each training sample 111 may relate to a binary tuple format. For example, for a depth estimation task, the training sample 111 may include a model input 112 and a model output 113. The model input 112 may include a video frame, and the model output 113 may include a ground-truth depth map corresponding to the video frame. The training samples 111 including the model inputs 112 and model outputs 113 may be used to train the depth estimation model 130. For example, the training process may be iteratively performed with a large number of training samples. The depth estimation model 130 may be trained via forward propagation and backpropagation. The parameter value of the depth estimation model 130 may be updated and adjusted during training.

After training is complete, a depth estimation model 130′ may be obtained. At this time, the parameter value of the depth estimation model 130′ has been updated, and the depth estimation model 130′ may be used to implement the video depth estimation task in the model application stage based on the updated parameter value. In the model application stage, the model depth estimation model 130′ (the depth estimation model 130′ at this time has a trained parameter value) may be configured to perform a corresponding task through the model application platform 140. For example, a model input 141 in a video depth estimation task may be received and a corresponding model output 142 may be output.

In FIG. 1, the model training platform 120 and the model application platform 140 may include any computing system having computing capabilities, such as various computing devices/systems, terminal devices, servers, and the like. The terminal device may relate to any type of mobile terminal, fixed terminal, or portable terminal, including a mobile phone, a desktop computer, a laptop computer, a notebook computer, a netbook computer, a tablet computer, a media computer, a multimedia tablet, or any combination thereof, including accessories and peripherals of these devices, or any combination thereof. The servers include, but are not limited to, mainframes, edge computing nodes, computing devices in a cloud environment, and the like.

It should be understood that the structure and function of the environment 100 is described for illustrative purposes only and does not imply any limitation to the scope of the present disclosure.

### Example Processes

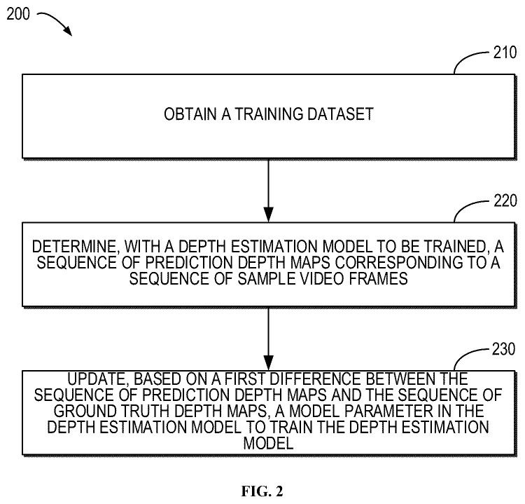

Some example embodiments of the present disclosure will be described below with continued reference to the accompanying drawings. FIG. 2 illustrates a flowchart of a model training process 200 according to some embodiments of the present disclosure. Part or all of the process 200 may be implemented by the model training platform 120 or may be implemented by another device, for example, may be implemented by another remote device (a terminal device or a service device) having a computing capability. In the following, for ease of discussion, the execution of process 200 is described in the perspective of model training platform 120, but this is merely illustrative.

At block 210, the model training platform 120 obtains a training dataset. The training dataset includes at least a sequence of sample video frames and a sequence of ground truth depth maps corresponding to the sequence of sample video frames. The sequence of ground truth depth maps includes a plurality of first ground truth depth maps. Each sequence of sample video frames may include a plurality of sample video frames. Each of the first ground truth depth maps includes depth information of a corresponding sample video frame. The sample video frames herein and the corresponding sequence of ground truth depth maps actually constitute training samples of the depth estimation model 130. In some examples, the training dataset includes a sample video, and the sample video may include a plurality of sequences of sample video frames. As an example, after obtaining the sample video, the model training platform 120 may divide the sample video into a plurality of consecutive sequences of sample video frames.

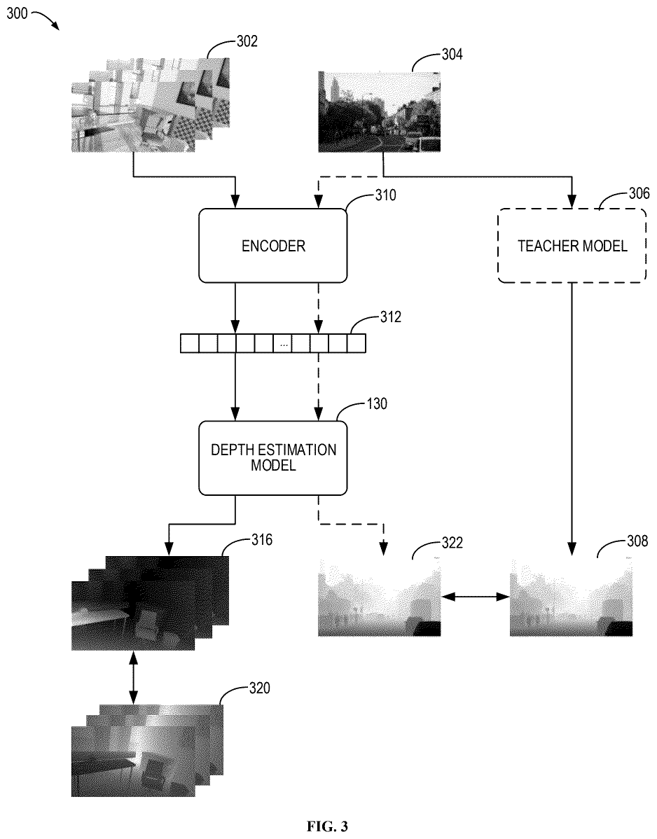

In some embodiments, the training data set may further include a sample image and a second ground truth depth map corresponding to the sample image. As an example, FIG. 3 illustrates a schematic diagram of an example architecture 300 of model training according to some embodiments of the present disclosure. As shown in FIG. 3, the model training platform 120 may pre-construct a teacher model 306. The teacher mode 306 may be the trained image depth estimation model 130. After obtaining the sample image 304, the model training platform 120 may determine, with the teacher model 306, a second ground truth depth map 308 corresponding to the sample image 304 based on the sample image 304. The second ground truth depth map 308 includes depth information of the sample image 304.

Referring back to the process 200, at block 220, the model training platform 120 determines, with the depth estimation model 130 to be trained, a sequence of prediction depth map corresponding to the sequence pf sample video frames. The sequence of prediction depth maps includes a plurality of first prediction depth maps. Each of the first prediction depth maps includes depth information of the corresponding sample video frame. The depth estimation model 130 may be constructed based on any suitable model structure, and the model structure of the depth estimation model 130 is not limited herein.

In some embodiments, the model training platform 120 may determine a sequence of sample feature representations based on visual encoding of the sequence of sample video frames. After that, the model training platform 120 may determine, with the depth estimation model 130, a sequence of prediction depth maps based on the sequence of sample feature representations. As an example, as shown in FIG. 3, the model training platform 120 may perform, with an encoder 310, visual encoding on the sequence of sample video frames to determine a sequence of sample feature representations 312. With the depth estimation model 130, a sequence of prediction depth maps 316 is then determined based on the sequence of sample feature representations 312.

In some embodiments, the model training platform 120 may determine a set of sample video frames for a current inference cycle from the sample video. The set of sample video frames includes a sequence of sample video frames to be inferred, at least one sample overlap frame that has been inferred in a previous inference cycle and at least one sample reference frame. The at least one sample overlap frame is adjacent to the sequence of sample video frames, and the at least one sample reference frame is located at a predetermined position of at least one set of sample video frames corresponding to at least one previous inference cycle, respectively. Regarding the predetermined position, in some examples, the sample reference frame may include a starting sample video frame of a set of sample video frames corresponding to a previous inference cycle, and the sample reference frame may also be a Ak-th sample video frame calculated from the starting of a set of sample video frames corresponding to a previous inference cycle.

After determining the set of sample video frames, the model training platform 120 may determine a sequence of sample feature representations corresponding to the set of sample video frames. With the depth estimation model 130, a sequence of prediction feature representations indicating the depth information is determined based on the sequence of sample feature representations. Then, a sequence of prediction depth maps corresponding to the sequence of sample video frames is determined based on the sequence of prediction feature representations. By introducing the sample reference frames and the sample overlap frames to train the depth estimation model 130, a cumulative scale drift of the sequence of depth maps determined by the trained depth estimation model 130 can be reduced. Especially for a long video, the cumulative scale drift of the predicted sequence of depth maps can be significantly reduced. Moreover, the scaling and displacement of the sequences of depth maps determined in adjacent inference cycles can be more similar, and flicker at the joint of the adjacent inference cycles can be avoided.

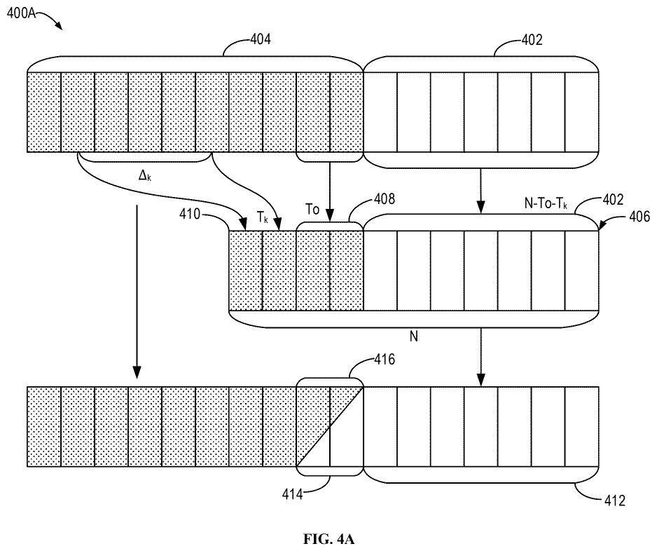

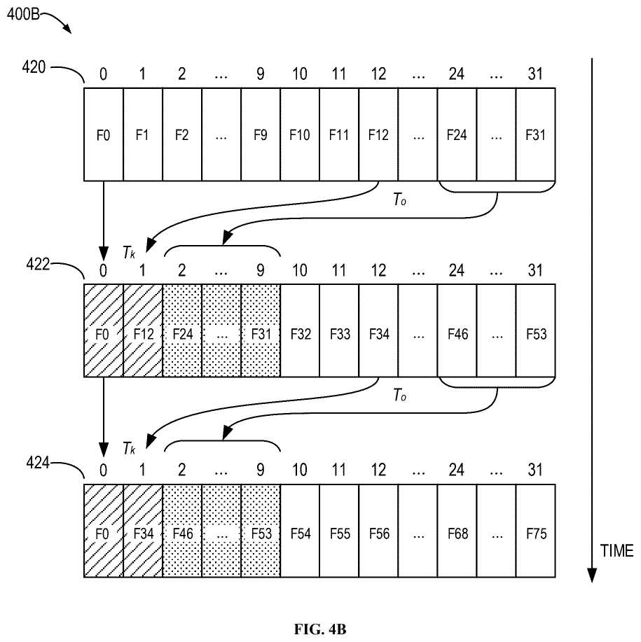

As an example, FIG. 4A illustrates a schematic diagram of an example scenario 400A of model training according to some embodiments of the present disclosure. As shown in FIG. 4A, the length of the set of sample video frames may be N. The model training platform 120 may determine a sequence of sample video frames 402 to be inferred in a current inference cycle from the sample video. The model training platform 120 may select T_{O} sample overlap frames 408 from a plurality of sample video frames 404 that have been inferred in a previous inference cycle. The model training platform 120 may also select Tk sample reference frames 410 from a plurality of predetermined positions of the plurality of sample video frames 404 that have been inferred in the previous inference cycle. A set of sample video frames 406 of length N are collectively formed by sequentially arranging Tk sample reference frames 410, To sample overlap frames 408, and a sequence of N-To-Tk sample video frames 402. After determining the set of sample video frames 406, the model training platform 120 may perform, with the encoder 310, visual encoding on the set of sample video frames 406 to obtain a corresponding sequence of sample feature representations. Then, with the depth estimation model 130, a sequence of prediction depth maps 412 corresponding to the sequence of sample video frames 402 is determined.

As another example, FIG. 4B illustrates a schematic diagram of an example scenario 400B of model training according to some embodiments of the present disclosure. As shown in FIG. 4B, the length of the set of sample video frames may be 32 frames. For a first inference cycle, the set of sample video frames 420 may include first 32 sample video frames (F0 to F31) of the sample video.

For the second inference cycle, the model training platform 120 may select a starting sample video frame F0 and a 13th sample video frame F12 from the set of sample video frames 420 corresponding to the first inference cycle as the sample reference frames. The model training platform 120 may further select, from the set of sample video frames 420 corresponding to the first inference cycle, 8 sample video frames (F24 to F31) at the end as the sample overlap frames. The model training platform 120 may further select 22 sample video frames after the set of sample video frames 420 from the sample video to form a sequence of sample video frames corresponding to the second inference cycle. A set of sample video frames 422 corresponding to the second inference cycle are collectively formed by 2 sample reference frames, 8 sample overlap frames, and a sequence of sample video frames with a length of 22.

For the third inference cycle, the model training platform 120 may select 22 sample video frames after the set of sample video frames 422 from the sample video to form a sequence of sample video frames corresponding to the third inference cycle. The model training platform 120 may a starting sample video frame F0 and a 13th sample video frame F34 from the set of sample video frames 422 as sample reference frames. The model training platform 120 may select, from the set of sample video frames 422, 8 sample video frames (F46 to F53) at the end as the sample overlap frames. Then, A set of sample video frames 424 are collectively formed by the sample video frame F0, the sample video frame F34, the sample video frame F46 to the sample video frame F53, and the sample video frames F54 to sample frame F75.

It should be noted that the foregoing combination manner of the sample video frame is merely illustrative. In actual application, sample reference frames may be selected from any suitable location. Any suitable number of sample reference frames and sample overlap frames may be selected. This is not limited in the embodiments of the present disclosure.

In some embodiments, the model training platform 120 may determine a sample feature representation set corresponding to the sample video based on encoding on sample video frames in the sample video. The sample feature representation set includes a sample feature representation corresponding to each of the sample video frames in the sample video. After determining the set of sample video frames, the model training platform 120 may select a set of sample feature representations corresponding to a set of sample video frames from the sample feature representation set to obtain a sequence of sample feature representations. In this way, repetitive encoding on sample reference frames and sample overlap frames can be avoided, which is beneficial for reducing system computing power consumption. As an example, as shown in FIG. 4B, In the case where a set of sample video frames 422 for the second inference cycle including a sample video frame F0, a sample video frame F12, and a sample video frame F24 to a sample video frame F53 is determined, sample feature representations corresponding to these sample video frames may be selected from the sample feature representation set to form a sequence of sample feature representations.

In some embodiments, the depth estimation model 130 may include at least one temporal layer. The model training platform 120 may perform, with the at least one temporal layer, self-attention mechanism processing on the sequence of sample feature representations in the time dimension of the sequence of sample video frames. Then, a sequence of prediction depth maps is determined based on the processed sequence of sample feature representations. In this way, interaction of temporal features between video frames can be promoted, thereby improving temporal consistency of the depth map sequence determined by the trained depth estimation model 130.

As an example, FIG. 5 illustrates a schematic diagram of an example architecture 500 of the depth estimation model 130 according to some embodiments of the present disclosure. The depth estimation model 130 shown in the example architecture 500 includes reassemble modules 504, 506, 508, 510, temporal layers 512, 514, 522, 528, fusion layers 520, 524, 530, and an output layer 534. The model training platform 120 may obtain a sequence of sample feature representations 502 corresponding to a set of sample video frames of the current inference cycle, and provide the sequence of sample feature representations to the depth estimation model 130. The depth estimation model 130 performs, with the reassemble module 510, down-sampling on the sequence of sample feature representations 502, and then performs, with the temporal layer 514, self-attention mechanism processing on the sampling result in the time dimension to obtain the feature representation 516. The depth estimation model 130 further performs, with the reassemble module 508, same-dimension sampling on the sequence of sample feature representations 502, and then performs, with the temporal layer 512, self-attention mechanism processing on the sampling result in the time dimension to obtain the feature representation 518. The depth estimation model 130 also performs, with 506 and 504 respectively, upsampling on the sequence of sample feature representations 502, respectively, to obtain a feature representation 526 and a feature representation 532. The feature representations 516, 518, 526, and 532 progressively increase in size, forming a pyramid like structure. In some cases, the data structure formed by the feature representations 516, 518, 526, and 532 may also be referred to as a feature pyramid.

The depth estimation model 130 may perform, with the fusion layer 520, feature fusion on the feature representation 516 and the feature representation 518, and then perform, with the temporal layer 522, self-attention mechanism processing on the fusion result. Feature fusion is performed, with the fusion layer 524, on the processed feature representation and the feature representation 526, and then a self-attention mechanism processing is performed, with the temporal layer 528, on the fusion result. Feature fusion is performed, with the fusion layer 530, on the processed feature representation and feature representation 532, and then, with the output layer 534, the sequence of prediction depth maps 316 is outputted based on the fused feature representation. It should be understood that the structure of the above depth estimation model 130 is merely illustrative. In practical applications, any suitable model structure including a temporal layer may be selected according to actual needs. This is not limited in the embodiments of the present disclosure.

In some embodiments, the sequence of prediction feature representations includes at least one reference prediction feature representation corresponding to at least one sample reference frame and a plurality of prediction feature representations corresponding to a sequence of sample video frames. Model training platform 120 may perform scale and shift alignment processing on the plurality of prediction feature representations based on a difference between the at least one reference prediction feature representation and at least one previous reference prediction feature representation for the at least one reference sample frame in the previous inference cycle. Then, a sequence of prediction depth maps is determined based on the plurality of prediction feature representations after the scale and shift alignment processing. In this way, accuracy and temporal consistency of the estimation result of the trained depth estimation model 130 are improved.

In some examples, the model training platform 120 may determine a scale parameter and a shift parameter based on the reference prediction feature representation determined in the current inference cycle and the previous reference prediction feature representation determined in the previous inference cycle. Then, with the scale parameter and the shift parameter, the scale and shift alignment processing is performed on the plurality of prediction feature representations.

As an example, the model training platform 120 may determine, with a linear least squares estimation, the scale parameter s and the shift parameter t based on the following formula:

$$A x = b \qquad ( 1 )$$

$$x = [ \begin{matrix}s \\ t\end{matrix} ] \qquad ( 2 )$$

Here, A represents reference prediction feature representations determined in a current inference cycle. The reference prediction feature representations may be represented as a depth value matrix. b represents the previous reference prediction feature representation determined in a previous inference cycle. s represents the scale parameter and t represents the shift parameter.

As another example, the model training platform 120 may perform, with the following formula, scale and shift processing on the prediction feature representation based on the scale parameter and the shift parameter.

$${M}^{‵} = M * s + t \qquad ( 3 )$$

Here, M represents prediction feature representations before processing; and M represents the processed prediction feature representations.

In some embodiments, the model training platform 120 may further update at least one overlap prediction depth map corresponding to at least one sample overlap frame based on the sequence of prediction feature representations to obtain at least one updated overlap prediction depth map corresponding to the at least one sample overlap frame. Therefore, the similarity and temporal consistency at the joint of the sequences of prediction depth maps formed in adjacent inference cycles can be improved, and jitter and flicker can be avoided.

In some examples, the sequence of prediction feature representations includes at least one sample overlap prediction feature representation corresponding to the at least one sample overlap frame. The model training platform 120 may obtain at least one first prediction depth map determined for at least one sample overlap frame in a previous inference cycle. At least one second prediction depth map of the at least one sample overlap frame in a current inference cycle is determined based on the at least one sample overlap prediction feature representation. Then, the model training platform 120 may perform weighted summation on the at least one first prediction depth map and the at least one second prediction depth map based on the weight of the at least one first prediction depth map and the weight of the at least one second prediction depth map, to obtain at least one updated overlap prediction depth map corresponding to the at least one sample overlap frame.

As an example, as shown in FIG. 4A, the model training platform 120 may obtain a plurality of first prediction depth maps 416 determined for the plurality of sample overlap frames 408 in the previous inference cycle. The model training platform 120 may further obtain a plurality of second prediction depth maps 414 determined for the plurality of sample overlap frames 408 in the current inference cycle. Then, the model training platform 120 may determine, with the following formula, the updated overlap prediction depth maps corresponding to the plurality of sample overlap frames 408:

$${D}_{{O}_{i}} = {D}_{{O}_{i}}^{p r e} \cdot {ω}_{i} + {D}_{{O}_{i}}^{c u r} \cdot ( 1 - {ω}_{i} ) \qquad ( 4 )$$

Here, D_{O}_{ᵢ} represents the updated overlap prediction depth map;

$${D}_{{O}_{i}}^{p r e}$$

represents the first prediction depth

$${D}_{{O}_{i}}^{c u r}$$

cycle; ωᵢ represents the weight coefficient, and linearly attenuates from 1 to 0 when i increases from 1 to T_{O}.

Returning to process 200, at block 230, the model training platform 120 updates, based on a first difference between the sequence of prediction depth maps and the sequence of ground truth depth maps, a model parameter in the depth estimation model 130 to train the depth estimation model. The first difference indicates a difference between a first depth change amount and a second depth change amount. The first depth change amount indicates a depth information change amount between adjacent first ground truth depth maps in the sequence of ground truth depth maps, and the second depth change amount indicates a depth information change amount between adjacent first prediction depth maps in the sequence of prediction depth maps.

In some embodiments, the model training platform 120 may determine first image regions in the adjacent first ground truth depth maps in the sequence of ground truth depth maps, the depth information change amount between the first image regions in the adjacent first ground truth depth maps being less than a change amount threshold. Second image regions in the adjacent first prediction depth maps in the sequence of prediction depth maps are determined, the second image regions corresponding to the first image regions. The model training platform 120 may determine the first depth change amount based on depth information of the first image regions in the adjacent first ground truth depth maps, the first depth change amount indicating the depth information change amount between the first image regions of the adjacent first ground truth depth maps. The model training platform 120 may further determine the second depth change amount base on depth information of the second image regions in the adjacent first prediction depth maps, the second depth change amount indicating the depth information change amount between the second image regions of the adjacent first prediction depth maps. In this way, in the training process of the depth estimation model 130, only the loss of the image region whose depth information change amount is less than the change amount threshold is selectively calculated. The sudden change of the depth map caused by the edges of the sample video frames, the dynamic object or other factors can be prevented from being introduced into the training process of the depth estimation model 130, thereby avoiding introducing unstable factors in the training process, which is beneficial to improving the training quality of the depth estimation model 130.

As an example, the model training platform 120 may update, with a loss function as shown below, the model parameter of the depth estimation model 130.

$${L}_{T G M} = \frac{1}{N - 1} {\sum }_{i = 1}^{N - 1} {‖ abs ( {d}_{i + 1} - {d}_{i} ) - abs ( {g}_{i + 1} - {g}_{i} ) ‖}_{1} \qquad ( 5 )$$

Here, L_{TGM} represents the loss function. dᵢ and dᵢ₊₁ represent a first prediction depth map corresponding to the i-th sample video frame and a first prediction depth map corresponding to the (i+1)th sample video frame, respectively; gᵢ and gᵢ₊₁ represent a first ground truth depth map corresponding to the i-th sample video frame and a ground truth depth map corresponding to the (i+1)th sample video frame, respectively; and the abs( ) represents taking the absolute value.

In some embodiments, in the case where the training dataset further includes a sample image and a second ground truth depth map corresponding to the sample image, the model training platform 120 may further determine, with the depth estimation model 130, a second prediction depth map corresponding to the sample image. After determining the second prediction depth map, the model training platform 120 may determine a second difference between depth information of the second ground truth depth map and the depth information of the second prediction depth map. Then, the model parameter in the depth estimation model 130 is updated based on the first difference and the second difference to train the depth estimation model 130. By combining the sample image to train the depth estimation model 130, convergence of the depth estimation model 130 can be achieved with limited sample videos, thereby achieving a better training effect.

As an example, as shown in FIG. 3, the model training platform 120 may determine the first difference based on the sequence of prediction depth maps 316 and the sequence of ground truth depth maps 320. The model training platform 120 may further perform, with the encoder 310, visual encoding on the sample image 304 to obtain a sample image feature representation corresponding to the sample image 304. The model training platform 120 may determine, with the depth estimation model 130, the second prediction depth map 322 based on the sample image feature representation. The model training platform 120 may determine a second difference between the depth information of the second prediction depth map 322 and the depth information of the second ground truth depth map 308. In turn, the model training platform 120 may update the model parameter of the depth estimation model 130 based on the first difference and the second difference.

In some embodiments, the second difference further includes a difference between depth information of the plurality of ground truth depth maps and depth information of the plurality of first prediction depth maps. The model training platform 120 may perform, based on a weight of the first difference and a weight of the second difference, weighted summation on the first difference and the second difference to determine a third difference. Then, the model parameter in the depth estimation model 130 is adjusted based on the third difference to train the depth estimation model 130.

As an example, the model training platform 120 may update the model parameter of the depth estimation model 130 by using a loss function as shown below.

$${L}_{a l l} = α {L}_{T G M} + β {L}_{s s i} \qquad ( 6 )$$

Here, Lₐₗₗ represents the total loss function; Lₛₛᵢ represents the spatial loss of the sample image; α and β represents the spatial consistency weight and the structural weight in the sample video frame, respectively.

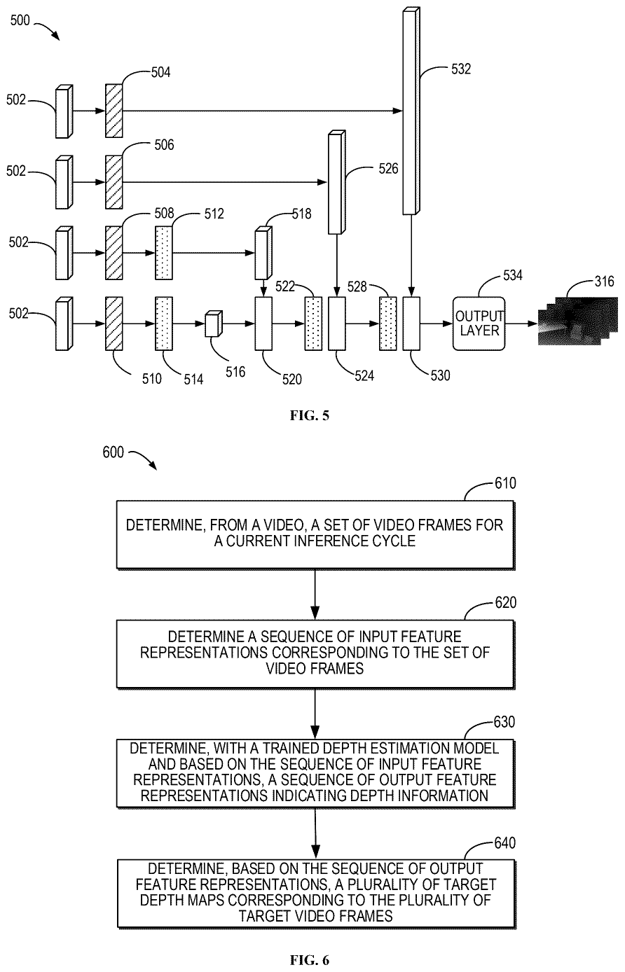

FIG. 6 illustrates a flowchart of a process 600 of depth prediction according to some embodiments of the present disclosure. Part or all of the process 600 may be implemented by the model application platform 140 or may be implemented by another device, for example, may be implemented by another remote device (a terminal device or a service device) having a computing capability. In the following, for ease of discussion, the execution of process 600 is described in the perspective of model application platform 140, but this is merely illustrative. It may be understood that the depth estimation model 130′ applied by the model application platform 140 may be formed based on the depth estimation model 130 through the foregoing training process.

At block 610, the model application platform 140 determines, from a video, a set of video frames for a current inference cycle. The set of video frames includes a plurality of target video frames to be inferred and at least one overlap frame that has been inferred in a previous inference cycle and at least one reference frame, the at least one overlap frame being adjacent to the plurality of target video frames, and the at least one reference frame being located at a predetermined position of at least one set of video frames corresponding to at least one previous inference cycle, respectively. Regarding the predetermined position, in some examples, the reference frame may include a starting video frame of a set of video frames corresponding to a previous inference cycle. The reference frame may also be a Ak-th video frame from the start of a set of video frames corresponding to a previous inference cycle. Certainly, the position of the above reference frame is merely illustrative, and this is not specifically limited in the embodiments of the present disclosure.

Regarding the manner of combining the target video frames, reference frames and overlap frames, a combination manner similar to that in which sample video frames, sample reference frames, and sample overlap frames are combined in the model training process may be used. For example, the model application platform 140 may also use the combination manner shown in FIG. 4A or FIG. 4B to combine target video frames, reference frames, and overlap frames. For details, reference may be made to the description of the combination manner of sample video frames, sample reference frames, and sample overlap frames in the foregoing model training process. Details are not described herein again.

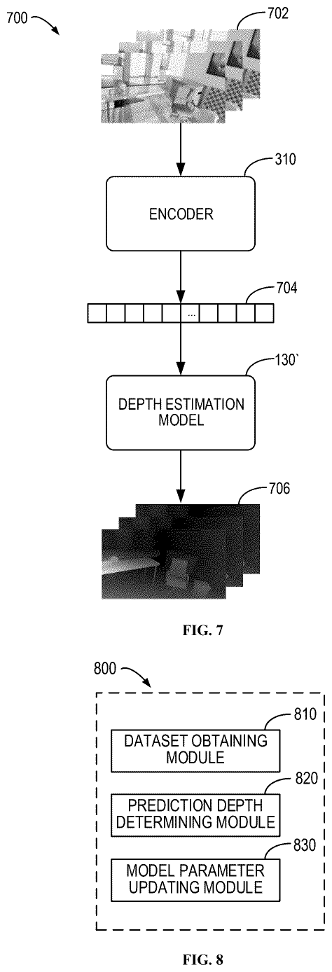

At block 620, the model application platform 140 determines a sequence of input feature representations corresponding to a set of video frames. In some embodiments, the model application platform 140 may perform, with the trained encoder, visual encoding on the set of video frames to obtain corresponding input feature representations. As an example, FIG. 7 illustrates a schematic diagram of an example architecture 700 of depth prediction according to some embodiments of the present disclosure. As shown in FIG. 7, after determining a set of video frames corresponding to a plurality of target video frames 702, the model application platform 140 may perform, with the trained encoder 310, visual encoding on the set of video frames, to determine a sequence of input feature representations 704 corresponding to the set of video frames.

In some embodiments, the model application platform 140 may determine, based on encoding on video frames in a video, an input feature representation set corresponding to the video. The input feature representation set includes an input feature representation corresponding to each of the video frames in the video. After determining a set of video frames of the current inference cycle, the model application platform 140 may select a set of input feature representations corresponding to the set of video frames from the input feature representation set to obtain a sequence of input feature representations. In this way, repeated encoding on reference frames and the overlap frames can be avoided, which is beneficial for reducing system computing power consumption.

Returning to process 600, at block 630, the model application platform 140 determines, with the trained depth estimation model 130′ and based on the sequence of input feature representations, a sequence of output feature representations indicating depth information. In some embodiments, the depth estimation model 130′ includes at least one temporal layer. The model application platform 140 may perform, with the at least one temporal layer, self-attention mechanism processing on the sequence of input feature representations in a time dimension of the set of video frames. Thereafter, the model application platform 140 may determine, based on the processed sequence of input feature representations, a sequence of output feature representations. In this way, interactions of temporal features between video frames can be facilitated, and it is beneficial for improving temporal consistency between the plurality of predicted target depth maps. It may be understood that the depth estimation model 130′ may use, for example, the example architecture 500 shown in FIG. 5 to process the sequence of input features.

With continued reference to process 600, at block 640, the model application platform 140 determines, based on the sequence of output feature representations, a plurality of target depth maps corresponding to the plurality of target video frames. Each of the target depth maps includes depth information corresponding to the respective target video frame. As an example, as shown in FIG. 7, the model application platform 140 may determine, with the depth estimation model 130′ and based on the sequence of input features 704, a sequence of output feature representations indicating depth information. Thereafter, a plurality of target depth maps 706 corresponding to the plurality of target video frames may be determined based on the sequence of output feature representations.

In some embodiments, the sequence of output feature representations at least includes at least one reference output feature representation corresponding to the at least one reference frame and a plurality of target output feature representations corresponding to the plurality of target video frames. The model application platform 140 may perform scale and shift alignment processing on the plurality of target output feature representations based on a difference between the at least one reference output feature representation and at least one previous reference output feature representation determined for the at least one reference frame in the previous inference cycle. Then, the model application platform 140 may determine the plurality of target depth maps based on the plurality of target output feature representations after the scale and shift alignment processing. In this way, it is beneficial for improving the accuracy and the temporal consistency of the predicted target depth maps. It may be understood that the model application platform 140 may perform, with, for example, formulas (1) to (3), scale and shift alignment processing on the plurality of target output features. For details, reference may be made to the introduction of formula (1) to formula (3) in the forgoing training process.

In some embodiments, the model application platform 140 may update, based on the sequence of output feature representations, at least one depth map corresponding to the at least one overlap frame to obtain at least one updated depth map corresponding to the at least one overlap frame. In this way, the overlap frame can be formed to have better similarity and temporal consistency with the target depth maps in both of the adjacent inference cycles. With the target depth maps of adjacent inference cycles connected through the overlap frames, the similarity and temporal consistency between the target depth maps of the adjacent inference cycles can be improved and jitter or flickering can be avoided, thereby improving the depth estimation quality.

In some embodiments, the sequence of output feature representations includes at least one overlap output feature representation corresponding to the at least one overlap frame. The model application platform 140 may obtain at least one first depth map determined for the at least one overlap frame in the previous inference cycle. The model application platform 140 further determines, based on at least the at least one overlap output feature representation, at least one second depth map of the at least one overlap frame in the current inference cycle. Weighted summation is performed on the at least one first depth map and the at least one second depth map based on a weight of the at least one first depth map and a weight of the at least one second depth map, to obtain at least one updated depth map corresponding to the at least one overlap frame. As an example, the model application platform 140 may perform, by using, for example, the formula (4), weighted summation processing on the first depth map and the second depth map. For details, reference may be made to the introduction of formula (4) in the forgoing training process.

It can be understood that the model application platform 140 usually needs to experience a plurality of inference cycles to complete depth predictions of all video frames in the video, so the process 600 may need to be cyclically executed multiple times during actual application. In addition, it should be noted that, in view of the fact that the model training process is similar to the model inference process, the embodiments that have been introduced in the model training process, are not described repeatedly or simply described only in the model inference process. Obviously, these embodiments may be applied to the model inference process. For details, reference may be made to the detailed introduction of these contents in the model training process.

In this way, in the embodiments of the present disclosure, it is considered that the depth information change amount between adjacent video frames determined with a depth estimation model should be consistent with the ground truth depth information change amount between the adjacent video frames. Based on this, embodiments of the present disclosure update the model parameter in the depth estimation model based on the first difference between the sequence of prediction depth maps and the sequence of ground truth depth maps to train the depth estimation model. Therefore, the temporal consistency of the depth estimation model can be effectively constrained, and the trained depth estimation model has a better performance in terms of temporal consistency.

### Example Apparatus and Device

Embodiments of the present disclosure also provide a corresponding apparatus for implementing the above method or process. FIG. 8 illustrates a schematic structural block diagram of an example apparatus 800 for model training according to some embodiments of the present disclosure. The apparatus 800 may be implemented as the model training platform 120 or included in the model training platform 120. The various modules/components in the apparatus 800 may be implemented by hardware, software, firmware, or any combination thereof.

As shown in FIG. 8, the apparatus 800 includes: a dataset obtaining module 810 configured to obtain a training dataset including at least a sequence of sample video frames and a sequence of ground truth depth maps corresponding to the sequence of sample video frames, the sequence of ground truth depth maps including a plurality of first ground truth depth maps; a prediction depth determining module 820 configured to determine, with a depth estimation model to be trained, a sequence of prediction depth maps corresponding to the sequence of sample video frames, the sequence of prediction depth maps including a plurality of first prediction depth maps; and a model parameter updating module 830 configured to update, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

In some embodiments, the first depth change amount and the second depth change amount are determined by: determining first image regions in the adjacent first ground truth depth maps in the sequence of ground truth depth maps, the depth information change amount between the first image regions in the adjacent first ground truth depth maps being less than a change amount threshold; determining second image regions in the adjacent first prediction depth maps in the sequence of prediction depth maps, the second image regions corresponding to the first image regions; determining the first depth change amount indicating the depth information change amount between the first image regions of the adjacent first ground truth depth maps; and determining the second depth change amount indicating the depth information change amount between the second image regions of the adjacent first prediction depth maps.

In some embodiments, the training dataset further includes a sample image and a second ground truth depth map corresponding to the sample image, and the apparatus 800 further includes: a sample image prediction module, configured to determine, with the depth estimation model, a second prediction depth map corresponding to the sample image, and the model parameter updating module 830 is further configured to: determine a second difference between depth information of the second ground truth depth map and depth information of the second prediction depth map; update, based on the first difference and the second difference, the model parameter in the depth estimation model to train the depth estimation model.

In some embodiments, the second difference further includes a difference between depth information based on the plurality of ground truth prediction depth maps and depth information of the plurality of first prediction depth maps. The model parameter updating module 830 is further configured to: perform, based on a weight of the first difference and a weight of the second difference, weighted summation on the first difference and the second difference to determine a third difference; and adjust, based on the third difference, the model parameter in the depth estimation model to train the depth estimation model.

In some embodiments, the prediction depth determining module 820 is further configured to: determine a sequence of sample feature representations based on visual encoding on the sequence of sample video frames; and determine, with the depth estimation model, the sequence of prediction depth maps based on the sequence of sample feature representations.

In some embodiments, the depth estimation model includes at least one temporal layer. The prediction depth determining module 820 is further configured to: perform, with the at least one time layer, self-attention mechanism processing on the sequence of sample feature representations in a time dimension of the sequence of sample video frames; and determine the sequence of prediction depth maps based on the processed sequence of sample feature representations.

In some embodiments, the training dataset includes a sample video including a plurality of sequences of sample video frames, and the prediction depth determining module 820 is further configured to: determine, from the sample video, a set of sample video frames for a current inference cycle, the set of sample video frames including the sequence of sample video frames to be inferred and at least one sample overlap frame that has been inferred in a previous inference cycle and at least one sample reference frame, the at least one sample overlap frame being adjacent to the sequence of sample video frames, and the at least one sample reference frame being located at a predetermined position of at least one set of sample video frames corresponding to at least one previous inference cycle, respectively; determine a sequence of sample feature representations corresponding to the set of sample video frames.

A sequence of prediction feature representations indicating depth information is determined with the depth estimation model and based on the sequence of sample feature representations; and the sequence of prediction depth maps corresponding to the sequence of sample video frames is determined based on the sequence of prediction feature representations.

In some embodiments, the sequence of prediction feature representations includes at least one reference prediction feature representation corresponding to the at least one sample reference frame and a plurality of prediction feature representations corresponding to the sequence of sample video frames, and the prediction depth determining module 820 is further configured to: perform scale and shift alignment processing on the plurality of prediction features based on a difference between the at least one reference prediction feature representation and at least one previous reference prediction feature representation for the at least one reference sample frame in the previous inference cycle; and determine the sequence of prediction depth maps based on the plurality of prediction feature representations after the scale and shift alignment processing.

In some embodiments, the apparatus 800 further includes: an overlap prediction depth updating module, configured to update, based on the sequence of prediction feature representations, at least one overlap prediction depth map corresponding to the at least one sample overlap frame, to obtain at least one updated overlap prediction depth map corresponding to the at least one sample overlap frame.

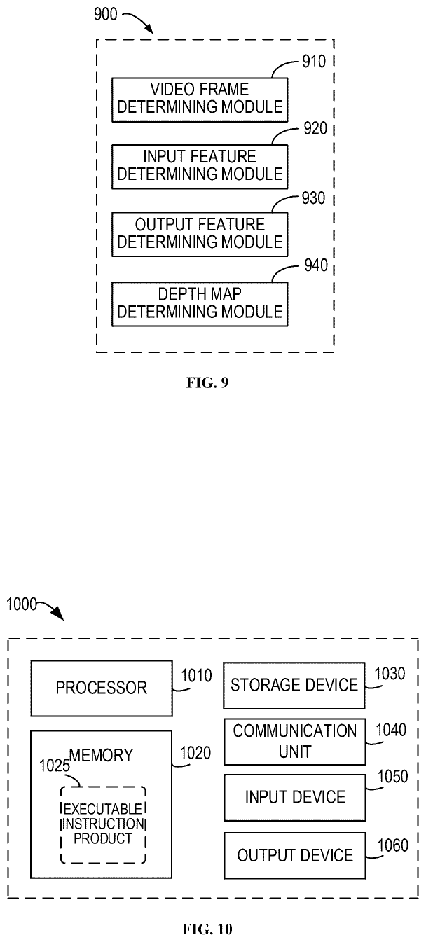

FIG. 9 illustrates a schematic structural block diagram of an example apparatus 900 for depth prediction according to some embodiments of the present disclosure. The apparatus 900 may be implemented as the model application platform 140 or included in the model application platform 140. The various modules/components in the apparatus 900 may be implemented by hardware, software, firmware, or any combination thereof.

As shown in FIG. 9, the apparatus 900 includes: a video frame determining module 910 configured to determine, from a video, a set of video frames for a current inference cycle, the set of video frames including a plurality of target video frames to be inferred and at least one overlap frame that has been inferred in a previous inference cycle and at least one reference frame, the at least one overlap frame being adjacent to the plurality of target video frames, and the at least one reference frame being located at a predetermined position of at least one set of video frames corresponding to at least one previous inference cycle, respectively; an input feature determining module 920 configured to determine a sequence of input feature representations corresponding to the set of video frames; an output feature determining module 930 configured to determining, with a trained depth estimation model and based on the sequence of input feature representations, a sequence of output feature representations indicating depth information; and a depth map determining module 940 configured to determine, based on the sequence of output feature representations, a plurality of target depth maps corresponding to the plurality of target video frames, each of the target depth maps including depth information corresponding to the respective target video frame.

In some embodiments, the sequence of output feature representations at least includes at least one reference output feature representation corresponding to the at least one reference frame and a plurality of target output feature representations corresponding to the plurality of target video frames, and the depth map determining module 940 is further configured to: perform scale and shift alignment processing on the plurality of target output feature representations based on a difference between the at least one reference output feature representation and at least one previous reference output feature representation determined for the at least one reference frame in the previous inference cycle; and determine the plurality of target depth maps based on the plurality of target output feature representations after the scale and shift alignment processing.

In some embodiments, the apparatus 900 further includes: an overlap depth map updating module configured to update, based on the sequence of output feature representations, at least one depth map corresponding to the at least one overlap frame to obtain at least one updated depth map corresponding to the at least one overlap frame.

In some embodiments, the sequence of output feature representations includes at least one overlap output feature representation corresponding to the at least one overlap frame, and the overlap depth updating module is further configured to: obtain at least one first depth map determined for the at least one overlap frame in the previous inference cycle; determine, based on at least the at least one overlap output feature representation, at least one second depth map of the at least one overlap frame in the current inference cycle; and perform, based on a weight of the at least one first depth map and a weight of the at least one second depth map, weighted summation on the at least one first depth map and the at least one second depth map to obtain at least one updated depth map corresponding to the at least one overlap frame.

In some embodiments, the input feature determining module 920 is further configured to: determine, based on encoding on video frames in the video, an input feature representation set corresponding to the video, the input feature representation set including an input feature representation corresponding to each of the video frames in the video; and select, from the input feature representation set, a set of input feature representations corresponding to the set of video frames to obtain the sequence of input feature representations.

In some embodiments, the depth estimation model includes at least one temporal layer, and the output feature determining module 930 is further configured to: perform, with the at least one temporal layer, self-attention mechanism processing on the sequence of input feature representations in a time dimension of the set of video frames; and determine, based on the processed sequence of input feature representations, the sequence of output feature representations.

The units/modules included in the apparatus 800, 900 may be implemented in various manners, including software, hardware, firmware, or any combination thereof. In some embodiments, one or more units/modules may be implemented using software and/or firmware, such as machine-executable instructions stored on a storage medium. In addition to or as an alternative to machine-executable instructions, some or all of the units/modules in the apparatus 800, 900 may be implemented, at least in part, by one or more hardware logic components. By way of example and not limitation, example types of hardware logic components that may be used include field programmable gate arrays (FPGAs), application specific integrated circuits (ASICs), application-specific standard product (ASSPs), system-on-chips (SOCs), complex programmable logic devices (CPLDs), and the like.

FIG. 10 illustrates a block diagram of an electronic device 1000 in which one or more embodiments of the present disclosure may be implemented. It should be understood that the electronic device 1000 illustrated in FIG. 10 is merely illustrative and should not constitute any limitation on the functionality and scope of the embodiments described herein. The electronic device 1000 shown in FIG. 10 may include the model training platform 120 or the model application platform 140 of FIG. 1, the apparatus 800 of FIG. 8, or the apparatus 900 of FIG. 9 or be implemented as the model training platform 120 or the model application platform 140 of FIG. 1, the apparatus 800 of FIG. 8, or the apparatus 900 of FIG. 9.

As shown in FIG. 10, the electronic device 1000 is in the form of a general-purpose electronic device. Components of the electronic device 1000 may include, but are not limited to, one or more processors 1010, a memory 1020, a storage device 1030, one or more communication units 1040, one or more input devices 1050, and one or more output devices 1060. The processor 1010 may be an actual or virtual processor and capable of performing various processes according to programs stored in the memory 1020. In multiprocessor systems, multiple processing units execute computer-executable instructions in parallel to improve parallel processing capabilities of electronic device 1000.

The electronic device 1000 typically includes a plurality of computer storage media. Such media may be any available media accessible by the electronic device 1000, including, but not limited to, volatile and non-volatile media, removable and non-removable media. The memory 1020 may be volatile memory (e.g., registers, caches, random access memory (RAM)), non-volatile memory (e.g., read-only memory (ROM), electrically erasable programmable read-only memory (EEPROM), flash memory), or some combination thereof. Storage device 1030 may be a removable or non-removable medium and may include a machine-readable medium, such as a flash drive, magnetic disk, or any other medium, which may be capable of storing information and/or data and may be accessed within electronic device 1000.

The electronic device 1000 may further include additional removable/non-removable, volatile/non-volatile storage media. Although not shown in FIG. 10, a disk drive for reading or writing from a removable, nonvolatile magnetic disk (e.g., a “floppy disk”) and an optical disk drive for reading or writing from a removable, nonvolatile optical disk may be provided. In these cases, each drive may be connected to a bus (not shown) by one or more data media interfaces. The memory 1020 may include a computer executable instruction product 1025 having one or more executable instruction modules configured to perform various methods or actions of various embodiments of the present disclosure.

The communications unit 1040 implements communications with other electronic devices over a communications medium. Additionally, the functionality of components of the electronic device 1000 may be implemented in a single computing cluster or multiple computing machines capable of communicating over a communication connection. Thus, the electronic device 1000 may operate in a networked environment using logical connections with one or more other servers, network personal computers (PCs), or another network node.

The input device 1050 may be one or more input devices, such as a mouse, a keyboard, a trackball, or the like. The output device 1060 may be one or more output devices, such as a display, a speaker, a printer, or the like. The electronic device 1000 may also communicate with one or more external devices (not shown) through the communication unit 1040 as needed, external devices such as storage devices, display devices, etc., communicate with one or more devices that enable a user to interact with the electronic device 1000, or communicate with any device (e.g., a network card, a modem, etc.) that enables the electronic device 1000 to communicate with one or more other electronic devices. Such communication may be performed via an input/output (I/O) interface (not shown).

According to example implementations of the present disclosure, there is provided a computer-readable storage medium having computer-executable instructions stored thereon, where the computer executable instructions are executed by a processor to implement the method described above. According to example implementations of the present disclosure, a computer executable instruction product is further provided, the computer executable instruction product being tangibly stored on a non-transitory computer-readable medium and including computer-executable instructions, the computer-executable instructions being executed by a processor to implement the method described above.

Aspects of the present disclosure are described herein with reference to flowcharts and/or block diagrams of methods, apparatuses, devices, and computer executable instruction products implemented in accordance with the present disclosure. It should be understood that each block of the flowchart and/or block diagram, and combinations of blocks in the flowcharts and/or block diagrams, may be implemented by computer-readable executable instructions.

These computer executable instructions may be provided to a processor of a general purpose computer, special purpose computer, or other programmable data processing apparatus to produce a machine, such that the instructions, when executed by a processor of a computer or other programmable data processing apparatus, produce apparatus to implement the functions/acts specified in the flowchart and/or block(s) in block diagram. These computer executable instructions may also be stored in a computer-readable storage medium that cause the computer, programmable data processing apparatus, and/or other devices to function in a particular manner, such that the computer-readable medium storing instructions includes an article of manufacture including instructions to implement aspects of the functions/acts specified in the flowchart and/or block(s) in block diagram.

The computer executable instructions may be loaded onto a computer, other programmable data processing apparatus, or other devices, such that a series of operational steps are performed on a computer, other programmable data processing apparatus, or other devices to produce a computer-implemented process such that the instructions executed on a computer, other programmable data processing apparatus, or other devices implement the functions/acts specified in the flowchart and/or block(s) in block diagram.

The flowchart and block diagrams in the figures show architecture, functionality, and operation of possible implementations of systems, methods, and computer executable instruction products according to various implementations of the present disclosure. In this regard, each block in the flowchart or block diagram may represent a module, executable instructions, or portion of an instruction that includes one or more executable instructions for implementing the specified logical function. In some alternative implementations, the functions noted in the blocks may also occur in a different order than noted in the figures. For example, two consecutive blocks may actually be performed substantially in parallel, which may sometimes be performed in the reverse order, depending on the functionality involved. It is also noted that each block in the block diagrams and/or flowchart, as well as combinations of blocks in the block diagrams and/or flowchart, may be implemented with a dedicated hardware-based system that performs the specified functions or actions, or may be implemented in a combination of dedicated hardware and computer instructions.

Various implementations of the present disclosure have been described above, which are illustrative, not exhaustive, and are not limited to the implementations disclosed. Many modifications and variations will be apparent to those of ordinary skill in the art without departing from the scope and spirit of the various implementations illustrated. The selection of the terms used herein is intended to best explain the principles of the implementations, the practical application, or improvements to the technology in the marketplace, or to enable others of ordinary skill in the art to understand the various implementations disclosed herein.

1. A method for model training, comprising:
obtaining a training dataset comprising at least a sequence of sample video frames and a sequence of ground truth depth maps corresponding to the sequence of sample video frames, the sequence of ground truth depth maps comprising a plurality of first ground truth depth maps;
determining, with a depth estimation model to be trained, a sequence of prediction depth maps corresponding to the sequence of sample video frames, the sequence of prediction depth maps comprising a plurality of first prediction depth maps; and
updating, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

2. The method of claim 1, wherein the first depth change amount and the second depth change amount are determined by:
determining first image regions in the adjacent first ground truth depth maps in the sequence of ground truth depth maps, the depth information change amount between the first image regions in the adjacent first ground truth depth maps being less than a change amount threshold;
determining second image regions in the adjacent first prediction depth maps in the sequence of prediction depth maps, the second image regions corresponding to the first image regions;
determining the first depth change amount indicating the depth information change amount between the first image regions of the adjacent first ground truth depth maps; and
determining the second depth change amount indicating the depth information change amount between the second image regions of the adjacent first prediction depth maps.

3. The method of claim 1, wherein the training dataset further comprises a sample image and a second ground truth depth map corresponding to the sample image, and the method further comprises:
determining, with the depth estimation model, a second prediction depth map corresponding to the sample image, and
wherein updating the model parameter of the depth estimation model comprises:
determining a second difference between depth information of the second ground truth depth map and depth information of the second prediction depth map; and
updating, based on the first difference and the second difference, the model parameter in the depth estimation model to train the depth estimation model.

4. The method of claim 3, wherein the second difference further comprises a difference between depth information of the plurality of ground truth depth maps and depth information of the plurality of first prediction depth maps, and
wherein updating based on the first difference and the second difference the model parameter in the depth estimation model comprises:
performing, based on a weight of the first difference and a weight of the second difference, weighted summation on the first difference and the second difference to determine a third difference; and
adjusting, based on the third difference, the model parameter in the depth estimation model to train the depth estimation model.

5. The method of claim 1, wherein determining the sequence of prediction depth maps comprises:
determining a sequence of sample feature representations based on visual encoding on the sequence of sample video frames; and
determining, with the depth estimation model, the sequence of prediction depth maps based on the sequence of sample feature representations.

6. The method of claim 5, wherein the depth estimation model comprises at least one temporal layer, and
wherein determining, with the depth estimation model, the sequence of prediction depth maps based on the sequence of sample feature representations comprises:
performing, with the at least one time layer, self-attention mechanism processing on the sequence of sample feature representations in a time dimension of the sequence of sample video frames; and
determining the sequence of prediction depth maps based on the processed sequence of sample feature representations.

7. The method of claim 1, wherein the training dataset comprises a sample video comprising a plurality of sequences of sample video frames, and determining the sequence of prediction depth maps comprising:
determining, from the sample video, a set of sample video frames for a current inference cycle, the set of sample video frames comprising the sequence of sample video frames to be inferred and at least one sample overlap frame that has been inferred in a previous inference cycle and at least one sample reference frame, the at least one sample overlap frame being adjacent to the sequence of sample video frames, and the at least one sample reference frame being located at a predetermined position of at least one set of sample video frames corresponding to at least one previous inference cycle, respectively;
determining a sequence of sample feature representations corresponding to the set of sample video frames;
determining, with the depth estimation model and based on the sequence of sample feature representations, a sequence of prediction feature representations indicating depth information; and
determining, based on the sequence of prediction feature representations, the sequence of prediction depth maps corresponding to the sequence of sample video frames.

8. The method of claim 7, wherein the sequence of prediction feature representations comprises at least one reference prediction feature representation corresponding to the at least one sample reference frame and a plurality of prediction feature representations corresponding to the sequence of sample video frames, and
wherein determining the sequence of prediction depth maps corresponding to the sequence of sample video frames comprises:
performing scale and shift alignment processing on the plurality of prediction features based on a difference between the at least one reference prediction feature representation and at least one previous reference prediction feature representation for the at least one reference sample frame in the previous inference cycle; and
determining the sequence of prediction depth maps based on the plurality of prediction feature representations after the scale and shift alignment processing.

9. The method of claim 7, further comprising:
updating, based on the sequence of prediction feature representations, at least one overlap prediction depth map corresponding to the at least one sample overlap frame, to obtain at least one updated overlap prediction depth map corresponding to the at least one sample overlap frame.

10. A method for depth prediction, comprising:
determining, from a video, a set of video frames for a current inference cycle, the set of video frames comprising a plurality of target video frames to be inferred and at least one overlap frame that has been inferred in a previous inference cycle and at least one reference frame, the at least one overlap frame being adjacent to the plurality of target video frames, and the at least one reference frame being located at a predetermined position of at least one set of video frames corresponding to at least one previous inference cycle, respectively;
determining a sequence of input feature representations corresponding to the set of video frames;
determining, with a trained depth estimation model and based on the sequence of input feature representations, a sequence of output feature representations indicating depth information; and
determine, based on the sequence of output feature representations, a plurality of target depth maps corresponding to the plurality of target video frames, each of the target depth maps comprising depth information corresponding to the respective target video frame.

11. The method of claim 10, wherein the sequence of output feature representations at least comprises at least one reference output feature representation corresponding to the at least one reference frame and a plurality of target output feature representations corresponding to the plurality of target video frames, and
wherein determine the plurality of target depth maps corresponding to the plurality of target video frames comprises:
performing scale and shift alignment processing on the plurality of target output feature representations based on a difference between the at least one reference output feature representation and at least one previous reference output feature representation determined for the at least one reference frame in the previous inference cycle; and
determining the plurality of target depth maps based on the plurality of target output feature representations after the scale and shift alignment processing.

12. The method of claim 10, further comprising:
updating, based on the sequence of output feature representations, at least one depth map corresponding to the at least one overlap frame to obtain at least one updated depth map corresponding to the at least one overlap frame.

13. The method of claim 12, wherein the sequence of output feature representations comprises at least one overlap output feature representation corresponding to the at least one overlap frame, and updating the at least one depth map corresponding to the at least one overlap frame comprises:
obtaining at least one first depth map determined for the at least one overlap frame in the previous inference cycle;
determining, based on at least the at least one overlap output feature representation, at least one second depth map of the at least one overlap frame in the current inference cycle; and
performing, based on a weight of the at least one first depth map and a weight of the at least one second depth map, weighted summation on the at least one first depth map and the at least one second depth map to obtain at least one updated depth map corresponding to the at least one overlap frame.

14. The method of claim 10, wherein determining the sequence of input feature representations corresponding to the set of video frames comprises:
determining, based on encoding on video frames in the video, an input feature representation set corresponding to the video, the input feature representation set comprising an input feature representation corresponding to each of the video frames in the video; and
selecting, from the input feature representation set, a set of input feature representations corresponding to the set of video frames to obtain the sequence of input feature representations.

15. The method of claim 10, wherein the depth estimation model comprises at least one temporal layer, and wherein determining the sequence of output feature representations comprises:
performing, with the at least one temporal layer, self-attention mechanism processing on the sequence of input feature representations in a time dimension of the set of video frames; and
determining, based on the processed sequence of input feature representations, the sequence of output feature representations.

16. An electronic device, comprising:
at least one processor; and
at least one memory coupled to the at least one processor and storing instructions for execution by the at least one processor, the instructions, when executed by the at least one processor, causing the electronic device to perform operations comprising:
obtaining a training dataset comprising at least a sequence of sample video frames and a sequence of ground truth depth maps corresponding to the sequence of sample video frames, the sequence of ground truth depth maps comprising a plurality of first ground truth depth maps;
determining, with a depth estimation model to be trained, a sequence of prediction depth maps corresponding to the sequence of sample video frames, the sequence of prediction depth maps comprising a plurality of first prediction depth maps; and
updating, based on a first difference between the sequence of prediction depth maps and the sequence of ground truth depth maps, a model parameter in the depth estimation model to train the depth estimation model, the first difference indicating a difference between a first depth change amount and a second depth change amount, the first depth change amount indicating a depth information change amount between adjacent first ground truth depth maps in the sequence of ground truth depth maps, the second depth change amount indicating a depth information change amount between adjacent first prediction depth maps in the sequence of prediction depth maps.

17. The electronic device of claim 16, wherein the first depth change amount and the second depth change amount are determined by:
determining first image regions in the adjacent first ground truth depth maps in the sequence of ground truth depth maps, the depth information change amount between the first image regions in the adjacent first ground truth depth maps being less than a change amount threshold;
determining second image regions in the adjacent first prediction depth maps in the sequence of prediction depth maps, the second image regions corresponding to the first image regions;
determining the first depth change amount indicating the depth information change amount between the first image regions of the adjacent first ground truth depth maps; and
determining the second depth change amount indicating the depth information change amount between the second image regions of the adjacent first prediction depth maps.

18. The electronic device of claim 16, wherein the training dataset further comprises a sample image and a second ground truth depth map corresponding to the sample image, and the acts further comprise:
determining, with the depth estimation model, a second prediction depth map corresponding to the sample image, and
wherein updating the model parameter of the depth estimation model comprises:
determining a second difference between depth information of the second ground truth depth map and depth information of the second prediction depth map; and
updating, based on the first difference and the second difference, the model parameter in the depth estimation model to train the depth estimation model.

19. The electronic device of claim 18, wherein the second difference further comprises a difference between depth information of the plurality of ground truth depth maps and depth information of the plurality of first prediction depth maps, and
wherein updating based on the first difference and the second difference the model parameter in the depth estimation model comprises:
performing, based on a weight of the first difference and a weight of the second difference, weighted summation on the first difference and the second difference to determine a third difference; and
adjusting, based on the third difference, the model parameter in the depth estimation model to train the depth estimation model.

20. The electronic device of claim 16, wherein determining the sequence of prediction depth maps comprises:
determining a sequence of sample feature representations based on visual encoding on the sequence of sample video frames; and
determining, with the depth estimation model, the sequence of prediction depth maps based on the sequence of sample feature representations.
